(19) United States
(12) Patent Application Publication
(10) Pub. No.: US 2025/0321418 A1
(43) Pub. Date: Oct. 16, 2025

(54) COUPLING DEVICE FOR CLEANING SENSOR LENSES AND METHOD FOR INSTALLING A COUPLING DEVICE FOR CLEANING SENSOR LENSES

(71) Applicant: PETRÓLEO BRASILEIRO S.A. – PETROBRAS, Rio de Janeiro (BR)

(72) Inventors: Fabricio Da Graca MARTINI QUINTAS, Rio de Janeiro (BR); Marcelo Lemos SOARES, Rio de Janeiro (BR); Guilherme SCHMIDT, Rio de Janeiro (BR)

(21) Appl. No.: 19/173,129

(22) Filed: Apr. 8, 2025

(30) Foreign Application Priority Data
Apr. 11, 2024 (BR) 1020240070518

(51) Int. Cl. G02B 27/00; G03B 17/56

(52) U.S. Cl. CPC G02B 27/0006; G03B 17/56

(57) ABSTRACT

The present disclosure is applied to the field of maintenance of camera and sensor lenses and, more particularly, relates to a coupling device for cleaning sensor lenses including: a fixing portion having two fixing tabs, a hose guide rod, and a routing channel. The routing channel includes a straight channel section and a curved channel section having a termination facing the region formed between the two fixing tabs.

### FIELD OF THE DISCLOSURE

The present disclosure is applied in the field of maintenance of camera and sensor lenses and, more particularly, relates to a coupling device used for cleaning industrial sensor lenses, such as fire and gas detection sensors in industrial areas, as well as a method for installing the device.

### BACKGROUNDS OF THE DISCLOSURE

Commonly, fire and gas detection sensors installed in maritime units or industrial plants and which use optical detection principles (ultraviolet, spotting, etc.) are exposed to dirt and contamination of their lenses. Over time, the accumulation of dirt and contamination causes the lens of these sensors to become constantly obstructed, which prevents their correct operation and considerably reduces the protection of the sensor's operating area.

Thus, after the contamination or obstruction by dirt of the sensor lenses, it becomes necessary to perform cleaning so that the sensor does not lose effectiveness and put equipment and people around it at risk.

When such sensors are installed at floor level, within reach of people, cleaning can generally be done quickly and easily, since no specific procedures and/or equipment are required to access the same.

However, the sensors are often installed in hard-to-reach locations, which requires a great deal of effort and mobilization of resources (people and specific equipment), so that the lenses can be cleaned and the sensors can restore their full functions.

This is the case, for example, of sensors installed at height, over the sea, on towers, poles, or other hard-to-reach locations (which represents the majority of the installed sensors), where the lens cleaning process becomes complex and time-consuming, since it requires the assembly of scaffolding structures, or the employment of specialized labor such as industrial climbers.

Accordingly, considering the State of the Art in this field, there is a need to develop a device that is capable of cleaning sensors, or even cameras, installed in hard-to-reach places, such as, for example, at heights, in a safe, fast and effective manner, without requiring the mobilization of a large amount of equipment and professionals from different fields, including specific tools and specialized professionals.

### STATE OF THE ART

The search for the history led to some documents that disclose matters within the technological field of the present disclosure.

Document CN216679287U refers to an image-based fire detection alarm device, with dustproof and cleaning functions, which comprises a detector camera for monitoring the environment. One end of the detector camera is equipped with a lens, and the lens is equipped with a mechanism for dustproof cleaning of a mirrored surface. The cleaning mechanism comprises a water storage assembly, and the water storage assembly is removably installed in the detector camera. The water storage assembly is removably coated on the detector camera through threads. The water spray assembly is arranged on one side of the water storage assembly through a connecting plate, and the connecting plate is stably fixed to the detector camera. A water spray assembly is coated and wraps around the lens, so that the quick and flexible installation and the combination of the cleaning mechanism are carried out. The water liquid can be transported to the water spray assembly through a water pump on the water storage assembly, so as to quickly clean the lens, and, meanwhile, a water supplementation structure capable of preventing the water liquid from flowing back is adopted on the water storage assembly to supply water to the water storage assembly in real time, so that the lens can undergo dust-proof cleaning at any time and the working environment of the lens is improved.

However, the device disclosed by document CN216679287U requires that its installation in a monitoring device (such as a camera or a sensor, for example) be done with caution, since it requires that the tube that connects to the water source be engaged into the side groove of the camera. In addition, the engaging of the circular structure itself requires that the assembly be done preferably before the final installation of the camera (still on the ground), or by an industrial climber (specialized professional), in the case of the device being attached to the camera already in use.

Document U.S. Pat. No. 4,383,572A, in turn, discloses an infrared ray detection device for the rotor of a rotary regenerative heat exchanger, which includes a sensor having a viewing lens at the end of a movable support arm. The sensor is adapted to view the emission of infrared rays from the rotor. As the arm moves along a path adjacent to the rotor, it is aligned with a fixed nozzle that ejects a jet of cleaning fluid over the entire surface of the lens to remove dust deposits and thus maintain the lens in a clean condition.

However, document U.S. Pat. No. 4,383,572A does not disclose or suggest a device that is coupled to the sensor body and that is easy to install. In addition, the length of the piping used in said document will always need to be adapted so that the nozzle coincides with the height of the lens, whereas the coupling device of the present disclosure may be connected to any sensor, requiring only an installation tool capable of bringing the device to the height of the sensor, so that the same device may be installed in other sensors without the need for modifications to their structure.

Document CN107520165A discloses a smart camera cleaning device. A rotary arm is movably connected to a fixed arm through a rotary shaft, and a motor is arranged on the rotary arm and drives the rotary arm to swing back and forth around the axis of the rotary shaft. An air inlet of a water-gas dual-purpose pump penetrates through the outer wall of the rotary arm and communicates with the outer portion of the rotary arm, and a second electromagnetic valve is arranged at the air inlet. A heater is arranged at an outlet of the water-gas dual-purpose pump. An ultrasonic wave generator is arranged in a water tank. A humidity sensor is arranged in a camera. A control device is used to control the motor to make the rotary arm swing back and forth around the axis of the rotary shaft. According to the smart camera cleaning device, a lens can be cleaned more thoroughly through the cooperation of the cleaning process and the defogging process.

However, unlike the present disclosure, the device of CN107520165A does not disclose tabs that attach to the camera body by pressure. On the contrary, in CN107520165A the installation must be done at height, by specialized professionals, given the complexity of the assembled system.

Document CN113770145A discloses a camera auto-feedback cleaning device and method and belongs to the technical field of camera cleaning. The camera auto-feedback cleaning device comprises a flange plate, a telescopic mechanism, a connector, a cleaning nozzle, a water supply hose, a terminal controller, and a water tank. The flange plate is connected to the telescopic mechanism, the connector connects the telescopic mechanism, the water supply hose, and the cleaning nozzle, and the water supply hose is led out of the water tank. According to the camera auto-feedback cleaning device, whether cleaning is necessary or not is judged by recognizing a monitored image, and the automatic cleaning is achieved through a terminal cleaning device. The telescopic mechanism can prevent a camera from being protected by the cleaning device in a non-cleaning state; and the device can be installed on most gun-shaped cameras at present, and modification of existing monitoring equipment is facilitated.

However, the cleaning device of the aforementioned document CN113770145A cannot be installed practically, since it is necessary to attach a plate to the support structure of the camera by suitable fixing means such as screws or others.

Document CN113877870A relates to a self-cleaning device for a camera lens for monitoring a coal mine transport road, which comprises a bracket, a water circulation module, an anti-explosion water pump, a universal metal water spray tube, a narrow-angle adjustable flat nozzle, a magnesium-aluminum alloy hose, a two-color reflector, a water inlet tube, and a light-transmitting hydrophobic film.

However, unlike the present disclosure, the installation of the device disclosed by document CN113877870A requires that a bracket be installed on the lower portion of the camera bracket, so that this installation requires specialized labor to be done.

Document CN219965724U discloses a camera cleaning mechanism comprising a mounting box, a motor fixed inside the mounting box, and a cleaning disc fixed at the output end of the motor. The surface of the cleaning disc is fixedly connected with a cleaning cloth, and the lower part of the mounting shell is fixedly connected with a connecting strip. The other end of the connecting strip is fixedly connected with a fixing seat; the fixing seat is provided with an inner groove. The inner wall of the groove is inserted in a hinged way with a two-way screw, wherein the threaded sleeve is provided with two symmetrically arranged nut bars. In the device disclosed in CN219965724U, a screw, a connecting bar and an arc-shaped fixing plate are used. The screw is rotated, the connecting bar is moved linearly so that the two arc-shaped clamps fix the camera on the pipe; then, the device is fixedly mounted on the camera, and next when the motor is started, rotating the cleaning disc causes the cleaning disc to wipe the surface of the camera with a cleaning cloth, which reduces the force of the hand and improves the efficiency compared to the prior art.

However, the device in document CN219965724U discloses a gripping mechanism that requires human intervention to operate, since two side drums must be rotated so that the tabs move, as well as the structure containing the cleaning cloth.

### BRIEF DESCRIPTION OF THE DISCLOSURE

Currently, there is a lack of devices in the State of the Art that allow the cleaning of sensor or camera lenses installed at height or in hard to access locations, especially in maritime units and industrial plants. Normally, to clean this equipment, it is necessary to mobilize a team of specialized professionals (industrial climbers, for example), together with special tools and resources, such as rope access or assembly of scaffolding structures to access the lenses. Considering that the lenses of these devices need to be cleaned frequently, in short periods of time, so that they can function fully, the mobilization of an entire team of specialized professionals and a large number of resources necessary to get the operation underway becomes unfeasible, either due to the time spent cleaning and installing the structures themselves, or due to the financial resources spent. In addition, even if carried out by qualified professionals, the entire operation of installing access and cleaning structures of the equipment themselves puts the people involved at risk.

Thus, the present disclosure includes the development of a coupling device for cleaning the lens of an industrial sensor, or of a camera, so that the installation of this device dispenses with the use of equipment (such as, for example, scaffolding and/or access ropes) and specific professionals (such as an industrial climber), and can be done by a single person. Furthermore, the device itself is configured to be coupled to the sensor structure, so that cables and the construction of additional supports to attach the coupling device to the sensor are not necessary.

In addition, by installing the device in fire and gas detection sensors, it becomes possible to inject water or cleaning fluid directly into the sensor lens, through the available hose, from a safe and easily accessible location.

Without the need to install special resources and mobilize specialized labor for the task, the implementation of the lens cleaning coupling device developed by the present disclosure allows an immediate response in the event of sensor failure due to dirt on the lens, since it can be quickly activated, reducing the time in which the area protected by the sensor is unguarded.

In addition, the lens cleaning coupling device of the sensors of the present disclosure also provides an additional means for preventive cleaning, enabling frequent and scheduled cleaning, thus reducing sensor failure events, since it no longer accumulates dirt progressively.

Accordingly, the advantages and objectives of the present disclosure are achieved by providing a coupling device for cleaning sensor lenses comprising: a fixing portion having two fixing tabs; a hose guide rod; a routing channel, wherein the routing channel includes a straight channel section and a curved channel section having a termination facing the region formed between the two fixing tabs.

In addition, in one embodiment, the present disclosure includes a method of installing a coupling device for cleaning sensor lenses comprising: introducing a hose through a hole arranged in a lower portion of a base of a fixing portion along a routing channel; coupling an installation tool to an engaging protuberance disposed at the bottom of the base of the fixing portion; raising the device, by means of the installation tool, to the height at which the sensor is installed, so that the first hose end, in the proximity of the end of the routing channel, is facing the sensor lens; fixedly engaging the fixing tabs to the sensor body; coupling a second hose end, in the proximity of or on the ground, to a pumping device or cleaning fluid reservoir to provide a flow of cleaning fluid in a controlled manner along the hose.

### BRIEF DESCRIPTION OF THE FIGURES

The embodiments of the disclosure in question will be better understood when read in conjunction with the accompanying drawings. It should be understood, however, that the disclosure in question is not limited to the precise arrangements and instruments shown.

Thus, the present disclosure will now be described below with reference to its typical embodiments and with reference to the appended drawings, in which:

FIG. 1 shows an isometric view of a coupling device for cleaning sensor lenses, according to an embodiment of the present disclosure.

FIG. 2 shows a schematic right side view of the coupling device for cleaning sensor lenses, according to an embodiment of the present disclosure.

FIG. 3 shows a schematic rear view of the coupling device for cleaning sensor lenses, according to an embodiment of the present disclosure.

### DETAILED DESCRIPTION OF THE DISCLOSURE

In the following, reference is made in detail to the preferred embodiments of the present disclosure illustrated in the accompanying drawings. Whenever possible, the same or similar reference numerals will be used throughout the drawings to refer to the same or similar features. It should be noted that the drawings are in simplified form and are not represented to a precise scale, so that small variations are anticipated.

The present disclosure relates to a coupling device for cleaning camera or sensor lenses, such as fire and gas detection sensors in industrial areas, as well as to a method of installing such device.

Notably, the device of the present disclosure can be applied in several segments and industrial units, such as, for example, in a floating storage and transfer unit (Floating Production, Storage and Offloading-FPSO) in the oil and gas sector, in steel mills, food industries, among others. Furthermore, the device can also be applied in monitoring devices, such as surveillance cameras.

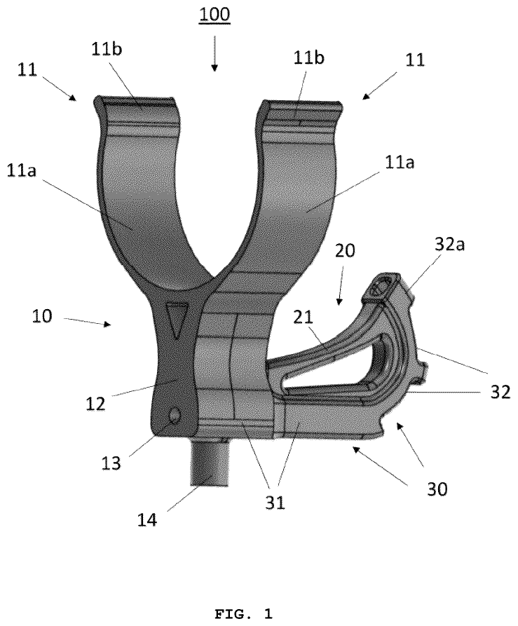

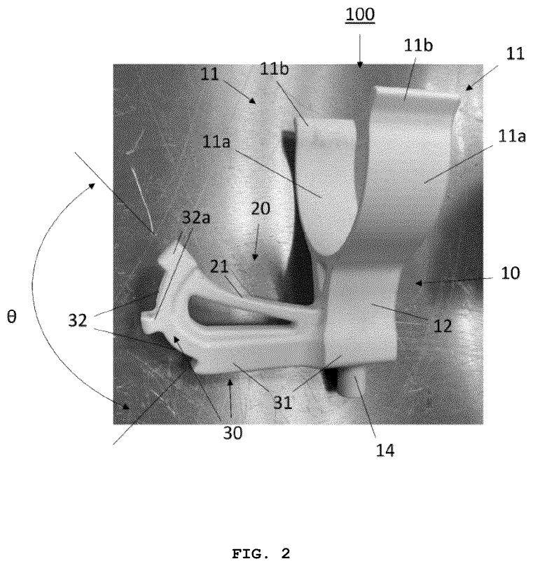

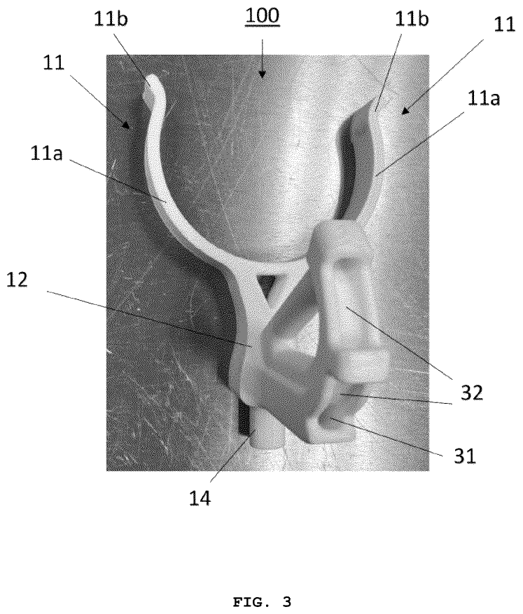

In this sense, reference is made to FIGS. 1, 2 and 3, which show a coupling device for cleaning sensor lenses 100, according to an embodiment of the present disclosure. In an embodiment of the present disclosure, the coupling device for cleaning sensor lenses 100 comprises: a fixing portion 10 having two fixing tabs 11; a hose guide rod 20; and a routing channel 30, wherein the routing channel 30 includes a straight channel section 31 and a curved channel section 32 having a termination facing the region formed between the two fixing tabs 11.

In one embodiment of the present disclosure, the fixing portion 10 has a general “Y” shape, wherein the two fixing tabs 11 are located at the top of the fixing portion 10 and form a general “U” or semicircular profile. Furthermore, each fixing tab 11 comprises a first fixing tab part 11a having a curvature facing the inside of the general “U” or semicircular profile and a second fixing tab part 11b, at the end of the first fixing tab part 11a, having a curvature facing the outside of the general “U” or semicircular profile. This change in curvature from the first fixing tab part 11a to the second fixing tab part 11b allows the fixing tabs 11, when pressed against a sensor body (not shown), to open around the sensor body and slide until they conform to its diameter, then closing (engaging) around the sensor body and keeping the coupling device 100 fixed by compression of the fixing tabs 11 to the sensor body.

In addition, in one embodiment of the present disclosure, the fixing portion 10 further comprises a base 12 having a hole 13 in its lower portion for introducing a hose (not shown) therethrough into the straight channel section 31 of the routing channel 30. As can be seen in FIGS. 1 to 3, in one embodiment of the present disclosure, the straight channel section 31 is at least partially formed in the base 12 of the fixing portion 10 and at least partially formed in the hose guide rod 20. In addition, the straight channel section 31 fully covers the surroundings of the hose portion introduced through the hole 13 and arranged in the straight channel section 31, so as to protect and align the hose portion introduced therein.

Furthermore, after passing through the straight channel section 31, the hose follows a path through the curved channel section 32, with its trajectory altered by means of the arc θ described by the curved channel section 32, so that the tip of the hose (first end of the hose) faces the region formed between the two fixing tabs 11, where the lens of the sensor to be cleaned is located. The curved channel section 32 is disposed at the rear portion of the hose guide rod 20 and has at least two rings 32a for securing around the hose passing through the curved channel section 32 and preventing the hose from detaching from the routing channel 30.

In one embodiment of the present disclosure, the hose guide rod 20 further comprises at least one reinforcing rib 21 for providing stiffness to the device 100.

Additionally, in one embodiment of the present disclosure, the fixing portion 10 further comprises an engaging protuberance 14 extending downwardly from the bottom of the base 12 of the fixing portion 10. At the engaging protuberance 14, an installation tool (not shown) is coupled so that the device 100 can be raised by a person to the height of the sensor. In one embodiment of the present disclosure, the installation tool is a tube, pipe, rod, or any other suitable tubular structure, which is engaged into the protuberance 14. In this way, after coupling the installation tool to the engaging protuberance 14, a person holding the installation tool raises the device 100 to the installation position (at the height at which the sensor is installed), so that the distal end of the curved channel section 32, where the hose tip is positioned (first hose end), is aligned and facing the lens of the sensor to be cleaned. The person holding the installation tool then exerts slight upward pressure with the tool so that the fixing tabs 11 are tensioned and engaged around the sensor body, as previously described. After the coupling device 100 has been fixedly engaged around the sensor body, the installation tool is decoupled from the engaging protuberance 14 and removed from the device 100.

The lens cleaning coupling device 100 of the present disclosure may be manufactured by means of additive manufacturing (three-dimensional printing) or by using traditional manufacturing means.

The following describes the method of installing a coupling device for cleaning sensor lenses 100, according to embodiments of the present disclosure.

Initially, the installation method comprises introducing a hose through a hole 13 arranged in a lower portion of a base 12 of a fixing portion 10 along a routing channel 30. In this manner, the hose is slid along the straight channel section 31 and then along the curved channel section 32.

Next, after the hose is introduced and adjusted in the routing channel 30, the method further comprises coupling an installation tool to an engaging protuberance 14 arranged at the bottom of the base 12 of the fixing portion 10, and raising the installation tool coupled to the device 100 to the height at which the sensor is installed, so that the tip of the hose (first hose end), in the proximity of the end of the routing channel 30, is facing the sensor lens.

The method of installing the coupling device 100 further comprises pressing fixing tabs 11 of the fixing portion 10 against the sensor body, so that the fixing tabs 11 are tensioned and engaged fixedly around the sensor body. After the device 100 is fixedly engaged to the sensor body, the installation tool is decoupled from the engaging protuberance 14 and removed from the device 100.

Furthermore, the method further comprises coupling a second hose end, the one located in the proximity of or on the ground, to a pumping device or cleaning fluid reservoir to provide a flow of cleaning fluid in a controlled manner along the hose, until the fluid is discharged through the first hose end, the one located at a height, towards the sensor lens. In this way, the flow of cleaning fluid is released in a controlled manner, directly impacting the sensor lens, thus effecting cleaning and removal of contaminants and impurities.

It should further be noted that several hoses of various lengths can be used, since the hose can be cut and fixed to structures close to or on the ground, so that its second end is in a location that is easily accessible to a person who will install the coupling device 100.

Furthermore, the cleaning fluid used can be water, compressed air, or any other cleaning medium suitable for sensor or camera lenses.

By using the coupling device 100 of the present disclosure in fire and gas detector sensors, it becomes possible to inject cleaning fluid directly into the sensor lens, through the available hose, from a safe and easily accessible location. In addition, without the need of using special resources and specialized labor for the task, the response becomes immediate in the event of sensor failure due to dirt on the lens, reducing the time in which the area protected by the sensor is unguarded. The use of the device of the present disclosure also provides an additional means for preventive cleaning, enabling frequent and scheduled cleaning, thus reducing sensor failure events, since it no longer accumulates dirt progressively. Furthermore, another advantage achieved by the device of the present disclosure concerns the ease of installation and use of the device at heights or in places that are hard to access, so that both can be performed by just one person, reducing risks, time required for installation and use, and costs involved.

Those skilled in the art will value the knowledge presented herein and will be able to reproduce the disclosure in the presented embodiments and in other variants, encompassed by the scope of the attached claims.

1. A coupling device for cleaning sensor lenses, the coupling device comprising:
a fixing portion having two fixing tabs;
a hose guide rod; and
a routing channel, and
wherein the routing channel includes a straight channel section and a curved channel section having a termination facing the region defined between the two fixing tabs.

2. The device according to claim 1, wherein the fixing portion has a general “Y” shape, wherein the two fixing tabs are located at the top of the fixing portion and define a general “U” or semicircular profile.

3. The device according to claim 2, wherein each fixing tab comprises a first fixing tab part having a curvature facing inside of the general “U” or semicircular profile and a second fixing tab part, located at the end of the first fixing tab part, having a curvature facing outside of the general “U” or semicircular profile.

4. The device according to claim 1, wherein the fixing portion further comprises a base having a hole in its lower portion for introducing a hose through the hole into the straight channel section of the routing channel.

5. The device according to claim 4, wherein the straight channel section is at least partially located at the base of the fixing portion and at least partially located at the hose guide rod.

6. The device according to claim 5, wherein the straight channel section covers the surroundings of the hose introduced through the hole and arranged in the straight channel section, so as to protect and align the hose introduced therein.

7. The device according to claim 6, wherein the curved channel section is arranged at the rear portion of the hose guide rod and has at least two rings for securing around the hose passing through the curved channel section and preventing the hose from coming loose from the routing channel.

8. The device according to claim 1, wherein the hose guide rod further comprises at least one reinforcing rib.

9. The device according to claim 1, wherein the fixing portion further comprises an engaging protuberance extending downwardly from the bottom of the base of the fixing portion, and
wherein an installation tool is coupled to the engaging protuberance so that the device is raised to the height of the sensor.

10. The device according to claim 9, wherein the installation tool comprises one or more of a tube, pipe or rod.

11. The device according to claim 9, wherein the fixing tabs engage around the sensor body, keeping the coupling device fixed by compression of the fixing tabs on the sensor body.

12. The device according to claim 1, wherein the coupling device is manufactured by additive manufacturing.

13. A method for installing a coupling device for cleaning sensor lenses, the method comprising:
introducing a hose through a hole arranged in a lower portion of a base of a fixing portion along a routing channel of a coupling device;
coupling an installation tool to an engaging protuberance arranged at a base of the fixing portion;
raising the device, by use of the installation tool, to the height at which a sensor is installed, so that a first hose end of the hose, in the proximity of the end of the routing channel, is facing a sensor lens;
fixedly engaging fixing tabs to a body of the sensor;
coupling a second hose end of the hose, in the proximity of or on the ground, to a pumping device or cleaning fluid reservoir to provide a flow of cleaning fluid in a controlled manner along the hose to the coupling device.
